(19) United States
(12) Patent Application Publication
(10) Pub. No.: US 2024/0257419 A1
(43) Pub. Date: Aug. 1, 2024

(54) VIRTUAL TRY-ON VIA WARPING AND PARSER-BASED RENDERING

(71) Applicant: META PLATFORMS TECHNOLOGIES, LLC, Menlo Park, CA (US)

(72) Inventors: Sen HE, London (GB); Cheng-Yang FU, San Francisco, CA (US); Nicole GALLAGHER, Astoria, NY (US); Antoine TOISOUL, London (GB); Tao XIANG, Ruislip (GB); Yanping XIE, London (GB)

(21) Appl. No.: 18/160,915

(22) Filed: Jan. 27, 2023

(51) Int. Cl. G06T 11/60; G06T 7/11; G06T 7/73

(52) U.S. Cl. CPC G06T 11/60; G06T 7/11; G06T 7/73; G06T 2207/20084

(57) ABSTRACT

One embodiment of the present invention sets forth a technique for performing a virtual try-on task. The technique includes determining a dense pose associated with a first figure depicted in a first image. The technique also includes converting, based on the dense pose, a second image of a first garment into a third image of a first warped garment. The technique further includes inputting the dense pose, one or more regions of the first image, and the third image of the first warped garment into a first neural network and generating, via execution of the first neural network, an output image that depicts the first figure wearing the first garment.

### BACKGROUND

### Field of the Various Embodiments

Embodiments of the present disclosure relate generally to machine learning and image editing and, more specifically, to virtual try-on via warping and parser-based rendering.

### Description of the Related Art

Recent technological advances have led to machine learning models that are capable of modifying or editing images in a semantically meaningful manner. For example, machine learning models can be trained to perform image editing tasks such as denoising, sharpening, blurring, colorization, compositing, super-resolution, image-to-image translation (e.g., transferring styles and characteristics between image domains), inpainting (e.g., filling in a missing region of an image), and/or outpainting (e.g., extending an image beyond the original borders).

One type of task that involves machine-learning-based image editing is virtual try-on, in which an image of a person is combined with an image depicting a garment to generate an image of the person wearing the garment. For example, a virtual try-on task could be incorporated into a “virtual changing room,” in which a user can select an image of himself or herself and a separate image of a garment to “try on.” The virtual changing room could use a machine learning model to combine visual details of both images into an output image that depicts the user wearing the garment.

One approach for implementing virtual try-on involves adapting a machine learning model that is trained to perform another type of image editing task to the task of transferring visual attributes from a first image of a garment onto a second image of a person wearing a different set of clothes. For example, a detail-preserving image-to-image translation network could be used to replace a shirt worn by the person in the second image with transfer textures from a different shirt depicted in the first image. However, this type of approach typically does not attempt to spatially align the garment in the first image with the pose of the person in the second image. Consequently, the resulting output image can exhibit unrealistic details, particularly in areas of one or both images that are occluded or spatially misaligned with one another.

More recently, improvements in virtual try-on technology have been achieved by warping garments depicted in a first set of images so that the warped garments are spatially aligned with the poses of people depicted in a second set of images before attributes from both sets of images are combined with one another. For example, a neural network can be used to warp a garment depicted in a first image so that the warped garment is spatially aligned with the pose of a person in a second image. The warped garment and second image can then be inputted into an image-to-image translation network to generate a corresponding output image that depicts the person in the same pose wearing the garment. The image-to-image translation network is thus able to transfer the attributes of the garment to the image of the person in a more accurate or realistic manner.

Existing approaches for performing garment warping estimate an “appearance flow” as a set of mappings from two-dimensional (2D) locations (e.g., pixel coordinates) in an image of a garment to corresponding 2D locations in an image of a person in a different pose. This appearance flow is then used to warp the image of the garment to match the pose of the person. However, these approaches lack global context, which negatively impacts the ability to perform accurate garment warping. More specifically, a conventional garment warping technique commonly uses local feature correspondences between features representing the image of the garment and feature representing the image of the person to perform appearance flow estimation. These local feature correspondences operate under the assumption that a given 2D location of the garment is within a certain distance of a corresponding 2D location of the person. Consequently, these local feature correspondences are unable to generate accurate appearance flows in the presence of a large spatial misalignment between locations on the garment and corresponding locations on the person. For example, these local feature correspondences can produce unrealistic results when the image of the person depicts a complex pose and/or occlusions of body parts or clothing, or when a full-body image of a person is used to perform virtual try-on of individual garment items such as tops, bottoms, and/or shoes.

As the foregoing illustrates, what is needed in the art are more effective techniques for performing machine-learning-based virtual try-on.

### SUMMARY

One embodiment of the present invention sets forth a technique for performing a virtual try-on task. The technique includes determining a dense pose associated with a first figure depicted in a first image. The technique also includes converting, based on the dense pose, a second image of a first garment into a third image of a first warped garment. The technique further includes inputting the dense pose, one or more regions of the first image, and the third image of the first warped garment into a first neural network and generating, via execution of the first neural network, an output image that depicts the first figure wearing the first garment.

One technical advantage of the disclosed techniques relative to the prior art is the ability to generate appearance flows that account for significant spatial misalignment between a garment depicted in one image and a person depicted in another image. Accordingly, the disclosed techniques can be used to generate more accurate or realistic virtual try-on results than conventional approaches that use only local feature correspondences between features representing an image of the garment and features representing an image of the person to perform appearance flow estimation. Another technical advantage of the disclosed techniques is the use of detailed semantic segmentation information to mask a region within the image of the person into which a specific type of garment is to be placed. Accordingly, the disclosed techniques allow a variety of garments (tops, bottoms, accessories, shoes, hats, etc.) to be combined with people or body parts depicted in images in a seamless manner. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a system configured to implement one or more aspects of various embodiments.

FIG. 2 is a more detailed illustration of the training engine and execution engine of FIG. 1, according to various embodiments.

FIG. 3 is a more detailed illustration of the flow estimation model of FIG. 2, according to various embodiments.

FIG. 4A illustrates the operation of the execution engine of FIG. 2 in using a flow estimation model to generate a warped garment image from an appearance image and garment image, according to various embodiments.

FIG. 4B illustrates the operation of the execution engine of FIG. 2 in using a rendering model to generate an output image from a corresponding dense pose, masked appearance image, and warped garment image, according to various embodiments.

FIG. 5 is a flow diagram of method steps for performing a virtual try-on task, according to various embodiments.

FIG. 6 is a block diagram of an embodiment of a near-eye display (NED) system in which a console operates, according to various embodiments.

FIG. 7A is a diagram of an NED, according to various embodiments.

FIG. 7B is another diagram of an NED, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### Overview

As discussed above, machine learning models that are trained to perform a virtual try-on task can include an image-to-image translation network that transfers visual attributes from a first image of a garment onto a second image of a person wearing a different set of clothes. These machine learning models can also include a neural network that predict appearance flows as mappings from two-dimensional (2D) locations (e.g., pixel coordinates) in the first image of the garment to corresponding 2D locations in the second image of the person in a different pose. These predicted appearance flows are used to warp the first image of the garment to match the pose of the person. The warped garment and second image can then be used by the image-to-image translation network to generate an output image that depicts the person in the same pose wearing the garment in a more accurate or realistic manner.

However, existing approaches for performing lack global context, which negatively impacts the ability to perform accurate garment warping. For example, a conventional garment warping model could perform appearance flow estimation using local feature correspondences, in which a given 2D location of the garment is assumed to be within a certain distance of a corresponding 2D location of the person. Consequently, these local feature correspondences are unable to generate accurate appearance flows when the image of the person depicts a complex pose and/or occlusions of body parts or clothing, a full-body image of a person is used to perform virtual try-on of individual garment items such as tops, bottoms, and/or shoes, or under other circumstances in which there is a large spatial misalignment between locations on the garment and corresponding locations on the person.

To improve the performance of machine learning models in virtual try-on tasks that involve significant misalignment between images of people and images of garments, the disclosed techniques include a flow estimation model that learns a global context associated with a first image of the garment and a second image of the person onto which the garment is to be fitted. The flow estimation model iteratively uses the global context and feature maps for both images to predict a coarse appearance flow between the images. The flow estimation model also uses local correspondence between regions of the feature maps that are mapped to one another via the coarse appearance flow to generate a refinement flow. The flow estimation model combines the coarse appearance flow and refinement flow into an appearance flow that is used to warp the garment. The warped garment, a dense pose for the image of the person, and a masked version of the image of the person are inputted into a rendering network with a residual U-Net architecture. In response to the input, the rendering network generates a corresponding image of the person wearing the garment.

### System Overview

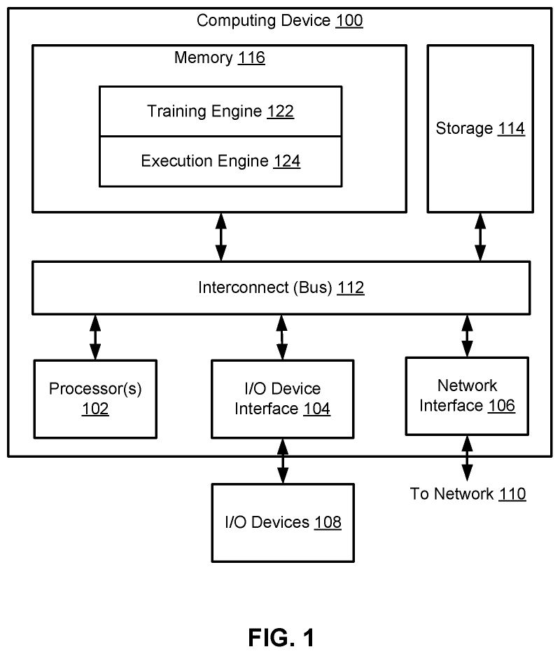

FIG. 1 illustrates a computing device 100 configured to implement one or more aspects of various embodiments. In one embodiment, computing device 100 may be a desktop computer, a laptop computer, a smart phone, a personal digital assistant (PDA), a tablet computer, a server, or any other type of computing device configured to receive input, process data, and optionally display images, and is suitable for practicing one or more embodiments. Computing device 100 is configured to run a training engine 122 and an execution engine 124 that reside in a memory 116.

It is noted that the computing device described herein is illustrative and that any other technically feasible configurations fall within the scope of the present disclosure. For example, multiple instances of training engine 122 and execution engine 124 could execute on a set of nodes in a distributed system to implement the functionality of computing device 100.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid state storage devices. Training engine 122 and execution engine 124 may be stored in storage 114 and loaded into memory 116 when executed.

Memory 116 includes a random access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 and execution engine 124.

In some embodiments, training engine 122 and execution engine 124 operate to train and execute a machine learning model to perform a virtual try-on task, in which an image of a person is combined with an image depicting a garment to generate an image of the person wearing the garment. The machine learning model includes a flow estimation model that generates appearance flows between pixel locations in the image of the garment and corresponding pixel locations in the image of the person. The appearance flows are generated based on a global context that characterizes the visual and spatial attributes of both the image of the person and the image of the garment, as well as local correspondences between feature maps for both images. The appearance flows are used to warp the garment, and the warped garment is inputted with a dense pose for the image of the person and a masked version of the image of the person into a rendering network with a residual U-Net architecture. In response to the input, the rendering network generates a corresponding image of the person wearing the garment.

### Virtual Try-on Via Warping and Parser-Based Rendering

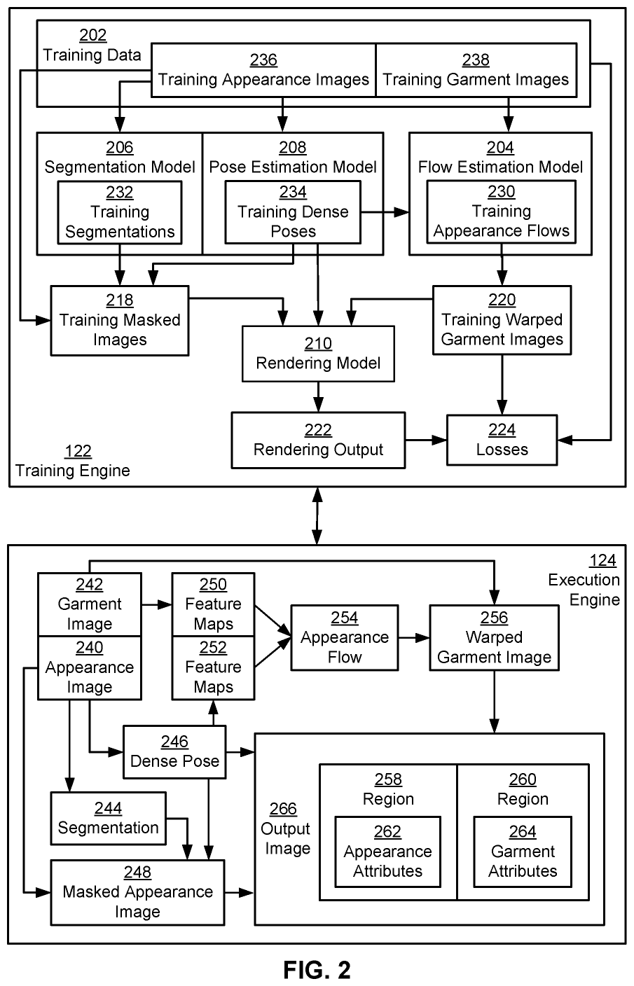

FIG. 2 is a more detailed illustration of training engine 122 and execution engine 124 of FIG. 1, according to various embodiments. As mentioned above, training engine 122 and execution engine 124 operate to train and execute a machine learning model to perform a virtual try-on task. During the virtual try-on task, a garment image 242 that depicts a standalone garment (or another representation of the garment) is combined with an appearance image 240 depicting a person (or another figure) into an output image 266 that depicts the person wearing the garment.

In one or more embodiments, appearance image 240 is denoted by a∈ [symbol] ^{3×H×W}, garment image 242 is denoted by g∈ [symbol] _{3×H×W}, and output image 266 is denoted by t∈ [symbol] ^{3×H×W}. Within output image 266, the garment in garment image 242 is fitted to the corresponding body parts of the person depicted in appearance image 240. Consequently, output image 266 includes a first region 258 that includes appearance attributes 262 from appearance image 240 and a second region 260 that includes garment attributes 264 from garment image 242. For example, region 258 could correspond to a portion of appearance image 240 that lie outside a region that is occupied by the garment depicted in garment image 242. Region 260 could correspond to a portion of appearance image 240 that has been replaced with a depiction of the garment in garment image 242. Both regions 258 could incorporate the context associated with the depiction of the person in appearance image 240.

In some embodiments, the context of a given image includes an object depicted in the image, a setting associated with the image, a geometric or spatial arrangement of shapes or objects within the image, and/or another semantic component of the image. For example, the context of an image depicting a clothed person could include a recognizable arrangement of body parts from the person, a pose associated with the person, a facial expression of the person, a body type associated with the person, and/or a recognizable arrangement of one or more garments worn by the person.

Visual attributes of a given image include colors, patterns, styles, edges, lines, and/or other attributes that define the manner in which objects in the image are depicted. For example, visual attributes of an image depicting a person could include a hairstyle, hair color, skin color, eye color, accessories worn by the person, facial expression, and/or other characteristics that can be used to define or identify the person. In another example, visual attributes of an image depicting a garment could include the texture, pattern, color, style, and/or other attributes of the fabric or material used in the garment.

Consequently, a given output image 266 that includes the context associated with a corresponding appearance image 240 can depict the identity, pose, expression, setting, and/or other higher-level characteristics from appearance image 240. Within this output image 266, region 258 can include colors, patterns, styles, edges, lines, and/or other visual appearance attributes 262 from appearance image 240, while region 260 can include colors, patterns, styles, edges, lines, and/or other visual garment attributes 264 from the garment in garment image 242. For example, appearance image 240 could depict a person wearing a shirt and a pair of paints in a certain pose, and garment image 242 could depict a standalone shirt. Output image 266 could depict the same person in the same pose but with the shirt from appearance image 240 replaced with the shirt from garment image 242.

As shown in FIG. 2, the machine learning model includes a flow estimation model 204, a segmentation model 206, a pose estimation model 208, and a rendering model 210. Each of flow estimation model 204, segmentation model 206, pose estimation model 208, and rendering model 210 includes a series of neural network layers that process one or more inputs and generate one or more corresponding outputs.

Segmentation model 206 includes a convolutional neural network (CNN), deep neural network (DNN), image-to-image translation network, and/or another type of machine learning model that generates a segmentation 244 of appearance image 240. In some embodiments, segmentation 244 includes predictions of labels representing different classes for individual pixels or regions of pixels in appearance image 240. For example, segmentation 244 could identify regions of appearance image 240 that correspond to specific types of garments (e.g., tops, bottoms, shirts, dresses, trousers, skirts, hats, shoes, etc.) worn by the person, skin on the person, body parts of the person, background, or other components of a depiction of a clothed person.

Pose estimation model 208 includes a CNN, DNN, image-to-image translation network, and/or another type of machine learning model that generates a dense pose 246 corresponding to appearance image 240. For example, pose estimation model 208 could include a Mask-RCNN architecture that represents features using feature pyramid networks and region of interest (ROI) aligned pooling. In some embodiments, dense pose 246 specifies a dense correspondence between pixels in appearance image 240 and a surface-based representation of a human body (or another type of figure). For example, pose estimation model 208 could generate, from an input appearance image 240, a corresponding dense pose 246 p∈ [symbol] ^{3×H×W}. The three channels of dense pose 246 specify, for each pixel that belongs to a person within appearance image 240, a body part (e.g., head, torso, lower arm, upper arm, lower leg, upper leg, hand, foot, etc.) represented by the pixel and a location on a 2D parameterization of the body part.

Flow estimation model 204 uses garment image 242 and dense pose 246 to generate an appearance flow 254 between garment image 242 and appearance image 240. More specifically, flow estimation model 204 converts garment image 242 into a set of feature maps 250 and converts dense pose 246 into a different set of feature maps 252. Flow estimation model 204 uses both sets of feature maps 250 and 252 to generate appearance flow 254 as a set of vectors (or other mappings) from 2D locations (e.g., pixel coordinates) in garment image 242 to corresponding 2D locations in dense pose 246. These vectors are used to convert garment image 242 into a warped garment image 256 that is spatially aligned with the corresponding body parts in appearance image 240.

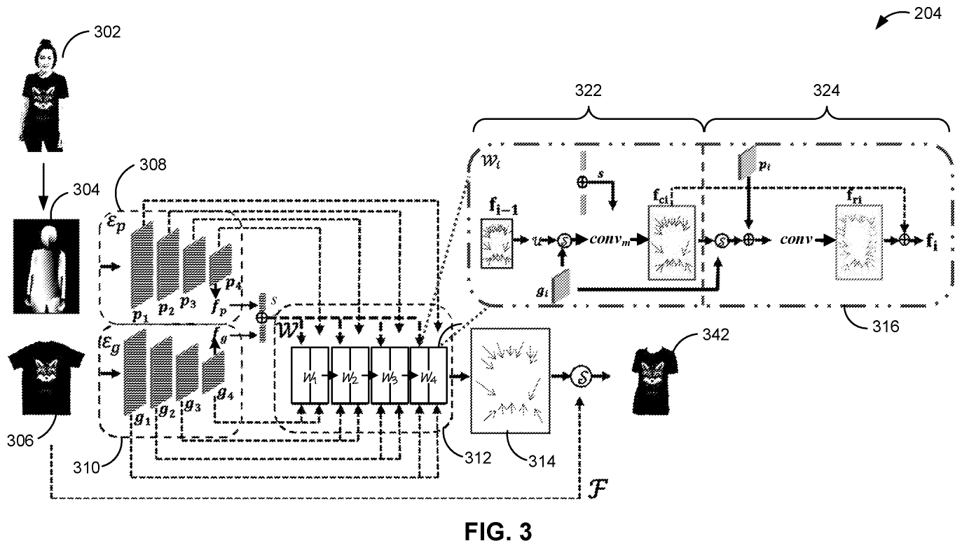

FIG. 3 is a more detailed illustration of flow estimation model 204 of FIG. 2, according to various embodiments. As shown in FIG. 3, flow estimation model 204 includes one encoder 308 that is denoted by εₚ and another encoder 310 that is denoted by ε_{g}. Encoders 308 and 310 can include (but are not limited to) CNNs, DNNs, residual neural networks, or other types of machine learning models.

Input into encoder 308 includes a dense pose 304 p for an image 302 that depicts a clothed person. Dense pose 304 can be obtained from or generated by pose estimation model 208, a human annotator, and/or another source. In response to the inputted dense pose 304, encoder 308 generates N sets of feature maps (e.g., feature maps 252 of FIG. 2) denoted by {pᵢ}₁^{N}. Similarly, input into encoder 310 includes an image 306 g of a standalone garment. In response to the inputted image 306, encoder 310 generates N sets of feature maps (e.g., feature maps 250 of FIG. 2) denoted by {gᵢ}₁^{N}. For example, encoders 308 and 310 could be composed of stacked residual blocks, and pᵢ∈ [symbol] ^{c}^{ᵢ}^{×h}^{ᵢ}^{×w}^{ᵢ} and gᵢ∈ [symbol] ^{c}^{ᵢ}^{×h}^{ᵢ}^{×w}^{ᵢ} could represent the ith feature maps extracted from the corresponding residual blocks in encoders 308 and 310, respectively. Additionally, cᵢ, hᵢ, and wᵢ could represent the number of channels, the height, and the width of the ith feature map produced by each encoder 308 and 310, with the resolution of the feature maps decreasing as i increases.

While FIG. 3 illustrates encoder 308 as generating four sets of feature maps p₁, p₂, p₃, and p₄ from dense pose 304 p and encoder 310 as generating four sets of feature maps g₁, g₂, g₃, and g₄ from image 306 g, it will be appreciated that the architecture and operation of encoders 308 and 310 can be adapted to generate any number of sets of feature maps. Similarly, the number of channels and/or resolutions associated with the feature maps can be varied to reflect the processing of different image types and/or image resolutions by encoders 308 and 310.

The lowest-resolution feature maps p_{N} and g_{N} outputted by encoders 308 and 310 are used to generate a global style vector s∈ [symbol] ^{c}:

$$s = [ {f}_{p} ( {p}_{N} ) , {f}_{g} ( {g}_{N} ) ] \qquad ( 1 )$$

In the above equation, fₚ and f_{g} are fully connected layers, c represents the length of the global style vector, and [⋅,⋅] denotes concatenation. The global style vector encodes global context (e.g., position, structure, etc.) associated with dense pose 304 and image 306.

Next, the global style vector and feature maps from encoders 308 and 310 are inputted into a warping module 312 that is denoted by [symbol] and composed of N stacked warping blocks { [symbol] ᵢ}₁^{N}. Each warping block 316 is denoted by [symbol] ᵢ and includes a style-based appearance flow prediction layer 302 and a local-correspondence-based appearance flow refinement layer 304.

Appearance flow prediction layer 302 of each block [symbol] ᵢ uses style modulation to predict a coarse flow f_{ci}:

$${f}_{ci} = {conv}_{m} ( 𝒮 ( {g}_{N + 1 - i} , 𝒰 ( {f}_{i - 1} ) ) , s ) \qquad ( 2 )$$

In the above equation, convₘ represents modulated convolution, [symbol] is the sampling operator, [symbol] is the upsampling operator, and fᵢ₋₁∈ [symbol] ^{2×h}^{_{i−1}}^{×w}^{_{i−1}} is the predicted flow from the previous warping block [symbol] ᵢ₋₁. Input into the first warping block 316 [symbol] ₁ includes the lowest resolution feature map generated by encoder 310 from image 306 and the global style vector:

$${f}_{c 1} = {conv}_{m} ( {g}_{N} , s ) \qquad ( 3 )$$

Because the predicted coarse flow f_{ci} is generated from a garment feature map and the global style vector, the coarse flow has a global receptive field and can handle significant spatial misalignment between dense pose 304 and image 306.

The coarse flow is refined using a corresponding appearance flow refinement layer 324 in the same warping block 316 [symbol] ᵢ to estimate a local fine-grained appearance flow fᵣᵢ:

$${f}_{ri} = conv ( 𝒮 ( {g}_{N + 1 - i} , {f}_{ci} ) , {p}_{N + 1 - i} ) \qquad ( 4 )$$

In the above equation, conv denotes convolution. Appearance flow refinement layer 324 thus estimates the local fine-grained appearance flow through a local correspondence between feature maps for dense pose 304 and feature maps for image 306 that are in the same receptive field. This local correspondence is achieved by warping the feature maps for image 306 using the coarse flow to be in the same receptive field as the feature maps for dense pose 304.

The coarse flow and local fine-grained appearance flow are summed to produce the output of each warping block:

$${f}_{i} = {f}_{ci} + {f}_{ri} \qquad ( 5 )$$

The predicted appearance flow 314 f_{N} from the last warping block [symbol] _{N} in warping module 312 is used to warp image 306 g to produce a corresponding image 342 ĝ of a warped garment:

$$\hat{g} = 𝒮 ( g , {f}_{N} ) \qquad ( 6 )$$

While FIG. 3 depicts the operation of flow estimation model 204 using dense pose 304 for a person wearing a garment in image 302, image 306 depicting the same garment, and image 342 that depicts a warped version of the same garment, it will be appreciated that flow estimation model 204 can be used to generate appearance flow 314 for any garment image and any dense pose. For example, flow estimation model 204 could be trained by inputting an image of a garment and a dense pose generated from an image of a person wearing the same garment. During training, the parameters of flow estimation model 204 would be updated in a way that reduced an error between the image of the warped garment generated by flow estimation model 204 and a corresponding representation of the garment in the image of the person. After flow estimation model 204 is trained, flow estimation model 204 could be used to warp a garment to spatially align with a dense pose generated from an image of a person wearing a different garment, thereby allowing the warped garment to be combined with the person's appearance into an image that depicts the person wearing the garment. The training and operation of flow estimation model 204 is described in further detail below.

Returning to the discussion of FIG. 2, rendering model 210 includes a CNN, DNN, residual neural network, and/or another type of machine learning model that generates output image 266, given input that includes warped garment image 256, dense pose 246, and a masked appearance image 248. For example, the operation of rendering model 210 could be represented using the following:

$$t = 𝒢 ( \hat{g} , {m}_{c} \cdot a , p ) \qquad ( 7 )$$

In the above equation, t represents output image 266, [symbol] represents rendering model 210, and m_{c} is a mask that is combined with appearance image 240 to generate masked appearance image 248.

Masked appearance image 248 includes portions of appearance image 240 that lie outside a space to be filled in with garment attributes 264 from warped garment image 256. For example, masked appearance image 248 could be generated by using segmentation 244 to identify a region of pixels in appearance image 240 to be filled with garment attributes 264 and removing (e.g., zeroing) pixel values from those pixels.

In one or more embodiments, masked appearance image 248 is generated based on a combination of segmentation 244 and dense pose 246. As discussed above, segmentation 244 includes predictions of labels representing skin, types of garments, or other objects depicted in appearance image 240 for regions of pixels in appearance image 240, and dense pose 246 specifies, for a given pixel in appearance image 240, a body part (e.g., head, torso, lower arm, upper arm, lower leg, upper leg, hand, foot, etc.) to which that pixel belongs and a location on a 2D parameterization of the body part that corresponds to that pixel. Per-pixel values of segmentation 244 can be combined (e.g., intersected, concatenated, etc.) with the corresponding per-pixel values of dense pose 246 to identify specific regions of skin from certain body parts (e.g., arms and/or legs) within appearance image 240. These regions of skin can be omitted from masked appearance image 248, along with regions of appearance image 240 that depict the garment to be replaced with garment attributes 264 of warped garment image 256.

In some embodiments, generation of masked appearance image 248 is conditioned on the type of garment depicted in garment image 242 and the corresponding warped garment image 256. For example, masked appearance image 248 could exclude pixels related to a torso, a shirt, and/or arms when garment image 242 and warped garment image 256 depict a shirt. In another example, masked appearance image 248 could exclude pixels related to a lower body, a skirt, trousers, and/or legs when garment image 242 and warped garment image 256 depict a garment to be worn on the lower body. In a third example, masked appearance image 248 could exclude pixels related to the entire body below the neck and all clothing when garment image 242 and warped garment image 256 depict a full-body garment such as a dress or a suit.

Training engine 122 trains flow estimation model 204, segmentation model 206, pose estimation model 208, and/or rendering model 210 to perform various sub-tasks within the virtual try-on task. More specifically, training engine 122 uses training data 202 that includes a set of training appearance images 236 and a set of training garment images 238 to train flow estimation model 204, segmentation model 206, pose estimation model 208, and/or rendering model 210. Each training appearance image in the set of training appearance images 236 depicts a person (or another figure) wearing a garment. Each training appearance image is paired with a corresponding training garment image from the set of training garment images 238 that depicts the same garment in a standalone fashion.

Training engine 122 applies flow estimation model 204, segmentation model 206, pose estimation model 208, and/or rendering model 210 to input data related to training data 202 to generate corresponding output data. As shown in FIG. 2, training engine 122 uses segmentation model 206 to generate training segmentations 232 of training appearance images 236. Training engine 122 uses pose estimation model 208 to generate training dense poses 234 from training appearance images 236. Training engine 122 then uses flow estimation model 204 to generate training appearance flows 230 using training dense poses 234 and training garment images 238 paired with training appearance images 236 for which training dense poses 234 were generated. Training engine 122 additionally uses training appearance flows 230 to generate training warped garment images 220 from the corresponding training garment images 238. Training engine 122 further generates training masked images 218 using training appearance images 236 and the corresponding training segmentations 232 and training dense poses 234. Finally, training engine 122 inputs training masked images 218, training dense poses 234, and training warped garment images 220 associated with individual pairs of training appearance images 236 and training garment images 238 into rendering model 210 and uses rendering model 210 to generate rendering output 222 that represents reconstructions of the corresponding training appearance images 236.

Training engine 122 also updates parameters of flow estimation model 204, segmentation model 206, pose estimation model 208, and/or rendering model 210 based on one or more losses 224 calculated using the inputs and/or outputs. For example, training engine 122 could use a training technique (e.g., gradient descent and backpropagation) to iteratively update parameters of flow estimation model 204, segmentation model 206, pose estimation model 208, and/or rendering model 210 in a way that minimized losses 224.

In some embodiments, losses 224 include a mean squared error (MSE), cross entropy loss, and/or another type of reconstruction loss between rendering output 222 and the corresponding training appearance images 236. Losses 224 can also, or instead, include a warping loss that is used to supervise the training of the warping module in flow estimation model 204:

$${L}_{g} = ‖ \hat{g} - {m}_{g} \cdot {p}_{gt} ‖ \qquad ( 8 )$$

In the above equation, L_{g} represents the warping loss, p_{gt} represents a training appearance image, and mg is a garment mask generated by a human parsing model (e.g., segmentation model 206) from the training appearance image. As a result, the warping loss measures the difference between pixel values in a training warped garment image and the portion of the corresponding training appearance image occupied by the same garment.

Losses 224 can also, or instead, include a smoothness regularization that is applied to the predicted training appearance flows 230 from each warping block in the warping module:

$${L}_{R} = {\sum }_{i} ‖ ∇ {f}_{i} ‖ \qquad ( 9 )$$

In the above equation, L_{R} represents the smoothness regularization, and ∥∇fᵢ∥ is a generalized charbonnier loss function.

Losses 224 can also, or instead, include one or more losses associated with adversarial training using a discriminator neural network (not shown). For example, losses 224 could include an adversarial loss that characterizes the probability that the discriminator neural network correctly distinguishes between real body parts depicted in training appearance images 236 and fake body parts depicted in rendering output 222 generated by rendering model 210. Training engine 122 could alternate training of the discriminator neural network to minimize the adversarial loss with training of flow estimation model 204, segmentation model 206, pose estimation model 208, and/or rendering model 210 to maximize the adversarial loss.

Losses 224 can also, or instead, include a perceptual loss that is generated based on skin regions identified by segmentation model 206. For example, the perceptual loss could include the following representation:

$${L}_{p} = {\sum }_{i} ‖ {ϕ}_{i} ( {m}_{s} \cdot t ) - {ϕ}_{i} ( {m}_{s} \cdot {p}_{gt} ) ‖ \qquad ( 10 )$$

In the above equation, Lₚ represents the perceptual loss, ϕᵢ is the ith block of a pre-trained feature extractor, such as (but not limited to) segmentation model 206 and/or another type of deep CNN (e.g., VGG, ResNet, Inception, MobileNet, DarkNet, AlexNet, GoogLeNet, etc.) that is trained to perform image classification, object detection, and/or other tasks related to the content in a large dataset of images. Additionally, ms is a mask of skin regions in a training appearance image, as generated by a human parsing model such as segmentation model 206.

In one or more embodiments, segmentation model 206 and pose estimation model 208 are pre-trained models that are not updated by training engine 122. Instead, segmentation model 206 and pose estimation model 208 are used to generate training segmentations 232 and training dense poses 234 that are used as inputs into flow estimation model 204 and rendering model 210 during training of flow estimation model 204 and rendering model 210. These training segmentations 232 and/or training dense poses 234 can also, or instead, be used to compute losses 224 that are used to update the parameters of flow estimation model 204 and rendering model 210.

After training of segmentation model 206, pose estimation model 208, flow estimation model 204, and/or rendering model 210 is complete, execution engine 124 executes segmentation model 206, pose estimation model 208, flow estimation model 204, and/or rendering model 210 to perform a virtual try-on task that combines garment image 242 depicting a standalone garment with appearance image 240 depicting a person (or another figure) into output image 266 that depicts the person wearing the garment. More specifically, execution engine 124 uses pose estimation model 208 to generate dense pose 246 for appearance image 240. Execution engine 124 also uses encoders 308 and 310 in flow estimation model 204 to generate feature maps 250 and 252 from garment image 242 and dense pose 246, respectively. Execution engine 124 uses the warping module in flow estimation model 204 to convert feature maps 250 and 252 into appearance flow 254 mappings between garment image 242 and dense pose 246 and applies appearance flow 254 to garment image 242 to generate warped garment image 256.

Execution engine 124 additionally uses segmentation model 206 to generate segmentation 244 of appearance image 240. Execution engine 124 generates a mask for appearance image 240 by combining segmentation 244 and dense pose 246 and applies the mask to appearance image 240 to generate masked appearance image 248. Execution engine 124 then inputs masked appearance image 248, dense pose 246, and warped garment image 256 into rendering model 210 and uses rendering model 210 to generate a corresponding output image 266. As mentioned above, output image 266 includes a first region 258 that depicts appearance attributes 262 from appearance image 240 and a second region 260 that depicts garment attributes 264 from garment image 242. Both regions 258 and 260 maintain the spatial and structural context associated with the depiction of the person in appearance image 240.

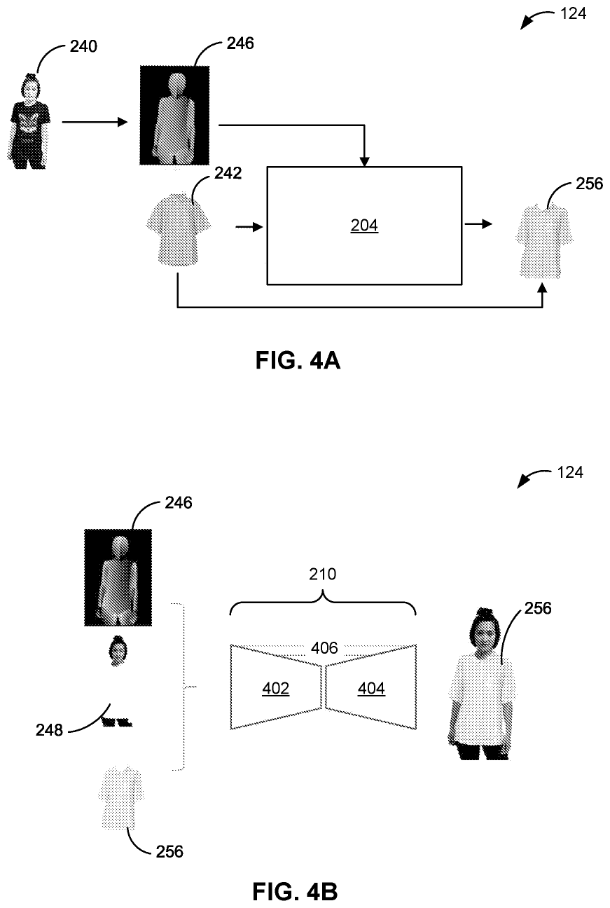

FIG. 4A illustrates the operation of execution engine 124 of FIG. 2 in using flow estimation model 204 to generate warped garment image 256 from appearance image 240 and garment image 242, according to various embodiments. Appearance image 240 depicts a person wearing a shirt, and garment image 242 includes a standalone image of a different shirt.

Execution engine 124 uses pose estimation model 208 to generate dense pose 246 from appearance image 240. Execution engine 124 inputs dense pose 246 and garment image 242 into flow estimation model 204 and applies an appearance flow generated by flow estimation model to garment image 242 to generate warped garment image 256.

FIG. 4B illustrates the operation of execution engine 124 of FIG. 2 in using rendering model 210 to generate output image 266 from a corresponding dense pose 246, masked appearance image 248, and warped garment image 256, according to various embodiments. As shown in FIG. 4B, masked appearance image 248 is generated by removing regions corresponding to the torso, arms, and/or shirt from appearance image 240 of FIG. 4A. Dense pose 246 is the same as dense pose 246 in FIG. 4A, and warped garment image 256 is the same as warped garment image 256 in FIG. 4A.

Execution engine 124 inputs dense pose 246, masked appearance image 248, and warped garment image 256 into rendering model 210. Rendering model 210 includes an encoder 402, a decoder 404, and a set of paths 406 that connect various layers or blocks in encoder 402 with corresponding layers or blocks in decoder 404. For example, rendering model 210 could include a residual U-Net architecture that includes residual blocks with skip connections in both encoder 402 and decoder 404.

In response to the inputted data, rendering model 210 generates output image 266 that includes the pose and appearance attributes 262 of the person in appearance image 240 but replaces the shirt worn by the person in appearance image 240 with the shirt depicted in warped garment image 256. Consequently, output image 266 corresponds to a photorealistic image that seamlessly overlays the garment depicted in warped garment image 256 onto the corresponding region of the person depicted in appearance image 240.

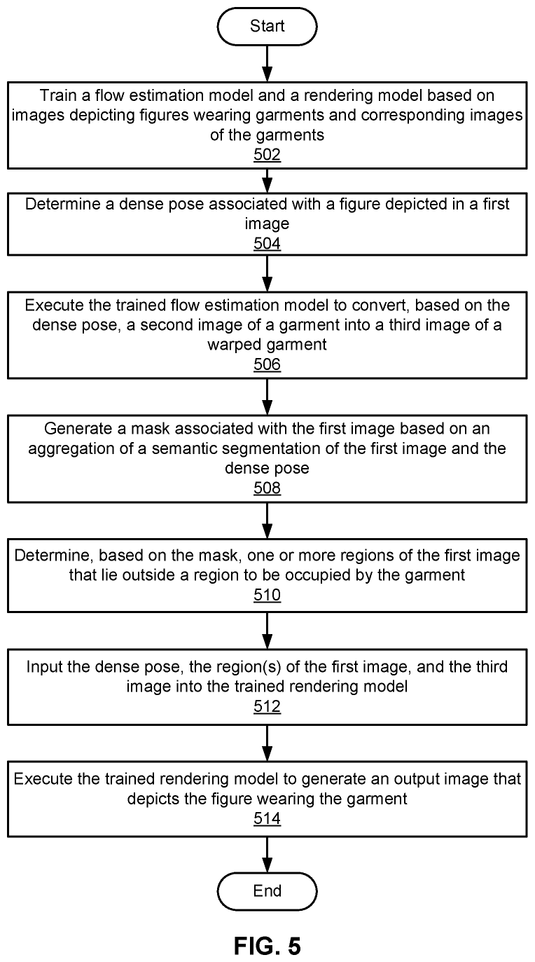

FIG. 5 is a flow diagram of method steps for performing a virtual try-on task, according to various embodiments. Although the method steps are described with reference to the systems of FIGS. 1-4B, persons skilled in the art will understand that any system may be configured to implement the method steps, in any order, in other embodiments.

As shown, in step 502, training engine 122 trains a flow estimation model and a rendering model based on images depicting figures (e.g., people, robots, mannequins, animals, animated figures, anthropomorphic figures, etc.) wearing garments and corresponding images of the garments. For example, training engine 122 could train the flow estimation model and rendering model based on pairs of images, where each pair of images includes an image depicting a figure wearing a garment in a certain pose and another standalone image of the same garment. Training engine 122 could train the flow estimation model to warp the image of the garment in a way that spatially aligns with the pose of the figure in the other image. Training engine 122 could also train the rendering model to reconstruct the image of the figure wearing the garment, given input that includes the warped garment, a dense pose for the figure in the other image, and a masked version of the image depicting the figure. Losses used to train the flow estimation model and rendering model include (but are not limited to) a reconstruction loss associated with the image outputted by the rendering model, a perceptual loss associated with skin regions in the image, an adversarial loss associated with a discriminator that evaluates generated body parts in the image, a warping loss associated with the warped garment, and/or a smoothness regularization associated with appearance flow vectors generated by the flow estimation model.

In step 504, execution engine 124 determines a dense pose associated with a figure depicted in a first image. For example, execution engine 124 could use a CNN, DNN, image-to-image translation network, and/or another type of machine learning model to generate the dense pose from the first image. The dense pose could specify, for each pixel that belongs to the figure within the first image, a body part (e.g., head, torso, lower arm, upper arm, lower leg, upper leg, hand, foot, etc.) represented by the pixel and a location of the pixel on a 2D parameterization of the body part.

In step 506, execution engine 124 executes the trained flow estimation model to convert, based on the dense pose, a second image of a garment into a third image of a warped garment. For example, execution engine 124 could input the second image and dense pose into the trained flow estimation model. Execution engine 124 could use one or more encoders in the trained flow estimation model to convert the dense pose and second image into respective sets of feature maps. Execution engine 124 could input the feature maps and a global style vector generated from a subset of the feature maps into a warping neural network in the trained flow estimation model. Execution engine 124 could use warping blocks that include appearance flow prediction layers and appearance flow refinement layers to generate a series of appearance flow vectors with increasingly high resolution. Execution engine 124 could then use the highest-resolution appearance flow vectors to warp pixels in the second image into the third image.

In step 508, execution engine 124 generates a mask associated with the first image based on an aggregation of a semantic segmentation of the first image and the dense pose. For example, execution engine 124 could use a segmentation model to generate the semantic segmentation from the first image. The semantic segmentation could identify regions of pixels that correspond to skin in the figure. The semantic segmentation could be intersected or otherwise combined with the dense pose to identify regions of the first image that correspond to skin of specific body parts (e.g., arm, leg, face, etc.). These identified regions can additionally be merged with one or more regions that depict clothing to be replaced with the garment into the mask.

In step 510, execution engine 124 determines, based on the mask, one or more regions of the first image that lie outside a region to be occupied by the garment. For example, execution engine 124 could apply the mask to the first image to remove the region to be occupied by the garment. When the garment corresponds to a top (e.g., a shirt), the region could include the torso of the figure below the neck, the arms of the figure, and/or the top worn by the figure within the first image. When the garment corresponds to a bottom (e.g., pants, skirt, etc.), the region could include the lower body of the figure, the legs of the figure, and/or the bottom worn by the figure within the first image. When the garment corresponds to a full-body garment (e.g., dress, suit, jumpsuit, etc.), the region could include everything below the neck of the figure within the first image. When the garment corresponds to a pair of shoes, the region could include everything below the lower legs of the figure within the first image. When the garment corresponds to a pair of gloves, the region could include everything below the upper arms of the figure within the first image.

In step 512, execution engine 124 inputs the dense pose, the region(s) of the first image identified in step 510, and the third image into the trained rendering model. In step 514, execution engine 124 executes the trained rendering model to generate an output image that depicts the figure wearing the garment. For example, execution engine 124 could input the dense pose, the region(s) of the first image identified in step 510, and the third image into a trained rendering model with a residual U-Net architecture. Execution engine 124 could then execute an encoder and a decoder in the residual U-Net to convert the input into the output image.

### Artificial Reality System

Embodiments of the disclosure may include or be implemented in conjunction with an artificial reality system. Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, e.g., create content in an artificial reality and/or are otherwise used in (e.g., perform activities in) an artificial reality. The artificial reality system that provides the artificial reality content may be implemented on various platforms, including a head-mounted display (HMD) or near-eye display (NED) connected to a host computer system, a standalone HMD or NED, a mobile device or computing system, or any other hardware platform capable of providing artificial reality content to one or more viewers.

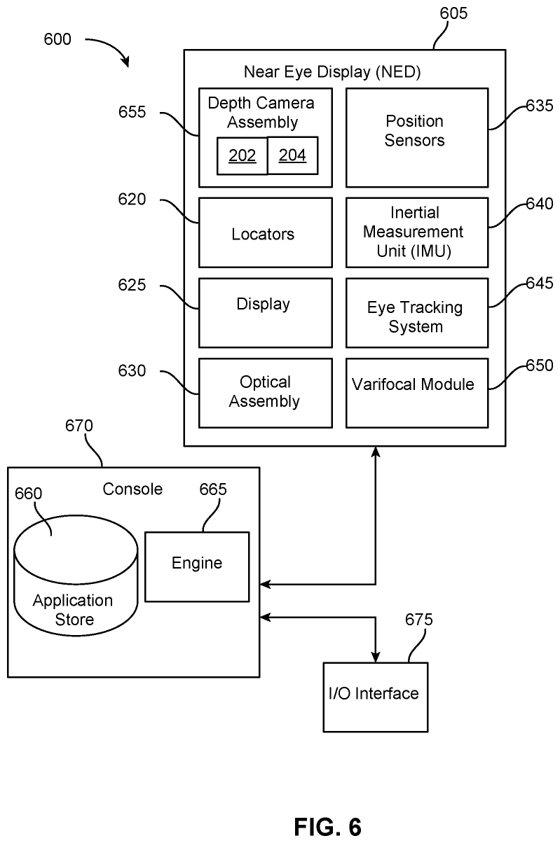

FIG. 6 is a block diagram of an embodiment of a near-eye display (NED) system 600 in which a console operates, according to various embodiments. The NED system 600 may operate in a virtual reality (VR) system environment, an augmented reality (AR) system environment, a mixed reality (MR) system environment, or some combination thereof. The NED system 600 shown in FIG. 6 comprises a NED 605 and an input/output (I/O) interface 675 that is coupled to the console 670.

While FIG. 6 shows an example NED system 600 including one NED 605 and one I/O interface 675, in other embodiments any number of these components may be included in the NED system 600. For example, there may be multiple NEDs 605, and each NED 605 has an associated I/O interface 675. Each NED 605 and I/O interface 675 communicates with the console 670. In alternative configurations, different and/or additional components may be included in the NED system 600. Additionally, various components included within the NED 605, the console 670, and the I/O interface 675 may be distributed in a different manner than is described in conjunction with FIGS. 1-3B in some embodiments. For example, some or all of the functionality of the console 670 may be provided by the NED 605 and vice versa.

The NED 605 may be a head-mounted display that presents content to a user. The content may include virtual and/or augmented views of a physical, real-world environment including computer-generated elements (e.g., two-dimensional or three-dimensional images, two-dimensional or three-dimensional video, sound, etc.). In some embodiments, the NED 605 may also present audio content to a user. The NED 605 and/or the console 670 may transmit the audio content to an external device via the I/O interface 675. The external device may include various forms of speaker systems and/or headphones. In various embodiments, the audio content is synchronized with visual content being displayed by the NED 605.

The NED 605 may comprise one or more rigid bodies, which may be rigidly or non-rigidly coupled together. A rigid coupling between rigid bodies causes the coupled rigid bodies to act as a single rigid entity. In contrast, a non-rigid coupling between rigid bodies allows the rigid bodies to move relative to each other.

As shown in FIG. 6, the NED 605 may include a depth camera assembly (DCA) 655, one or more locators 620, a display 625, an optical assembly 630, one or more position sensors 635, an inertial measurement unit (IMU) 640, an eye tracking system 645, and a varifocal module 650. In some embodiments, the display 625 and the optical assembly 630 can be integrated together into a projection assembly. Various embodiments of the NED 605 may have additional, fewer, or different components than those listed above. Additionally, the functionality of each component may be partially or completely encompassed by the functionality of one or more other components in various embodiments.

The DCA 655 captures sensor data describing depth information of an area surrounding the NED 605. The sensor data may be generated by one or a combination of depth imaging techniques, such as triangulation, structured light imaging, time-of-flight imaging, stereo imaging, laser scan, and so forth. The DCA 655 can compute various depth properties of the area surrounding the NED 605 using the sensor data. Additionally or alternatively, the DCA 655 may transmit the sensor data to the console 670 for processing. Further, in various embodiments, the DCA 655 captures or samples sensor data at different times. For example, the DCA 655 could sample sensor data at different times within a time window to obtain sensor data along a time dimension.

The DCA 655 includes an illumination source, an imaging device, and a controller. The illumination source emits light onto an area surrounding the NED 605. In an embodiment, the emitted light is structured light. The illumination source includes a plurality of emitters that each emits light having certain characteristics (e.g., wavelength, polarization, coherence, temporal behavior, etc.). The characteristics may be the same or different between emitters, and the emitters can be operated simultaneously or individually. In one embodiment, the plurality of emitters could be, e.g., laser diodes (such as edge emitters), inorganic or organic light-emitting diodes (LEDs), a vertical-cavity surface-emitting laser (VCSEL), or some other source. In some embodiments, a single emitter or a plurality of emitters in the illumination source can emit light having a structured light pattern. The imaging device includes camera sensors that capture ambient light in the environment surrounding NED 605, in addition to light reflected off of objects in the environment that is generated by the plurality of emitters. In various embodiments, the imaging device may be an infrared camera or a camera configured to operate in a visible spectrum. The controller coordinates how the illumination source emits light and how the imaging device captures light. For example, the controller may determine a brightness of the emitted light. In some embodiments, the controller also analyzes detected light to detect objects in the environment and position information related to those objects.

The locators 620 are objects located in specific positions on the NED 605 relative to one another and relative to a specific reference point on the NED 605. A locator 620 may be a light emitting diode (LED), a corner cube reflector, a reflective marker, a type of light source that contrasts with an environment in which the NED 605 operates, or some combination thereof. In embodiments where the locators 620 are active (i.e., an LED or other type of light emitting device), the locators 620 may emit light in the visible band (˜360 nm to 750 nm), in the infrared (IR) band (˜750 nm to 7700 nm), in the ultraviolet band (70 nm to 360 nm), some other portion of the electromagnetic spectrum, or some combination thereof.

In some embodiments, the locators 620 are located beneath an outer surface of the NED 605, which is transparent to the wavelengths of light emitted or reflected by the locators 620 or is thin enough not to substantially attenuate the wavelengths of light emitted or reflected by the locators 620. Additionally, in some embodiments, the outer surface or other portions of the NED 605 are opaque in the visible band of wavelengths of light. Thus, the locators 620 may emit light in the IR band under an outer surface that is transparent in the IR band but opaque in the visible band.

The display 625 displays two-dimensional or three-dimensional images to the user in accordance with pixel data received from the console 670 and/or one or more other sources. In various embodiments, the display 625 comprises a single display or multiple displays (e.g., separate displays for each eye of a user). In some embodiments, the display 625 comprises a single or multiple waveguide displays. Light can be coupled into the single or multiple waveguide displays via, e.g., a liquid crystal display (LCD), an organic light emitting diode (OLED) display, an inorganic light emitting diode (ILED) display, an active-matrix organic light-emitting diode (AMOLED) display, a transparent organic light emitting diode (TOLED) display, a laser-based display, one or more waveguides, other types of displays, a scanner, a one-dimensional array, and so forth. In addition, combinations of the display types may be incorporated in display 625 and used separately, in parallel, and/or in combination.

The optical assembly 630 magnifies image light received from the display 625, corrects optical errors associated with the image light, and presents the corrected image light to a user of the NED 605. The optical assembly 630 includes a plurality of optical elements. For example, one or more of the following optical elements may be included in the optical assembly 630: an aperture, a Fresnel lens, a convex lens, a concave lens, a filter, a reflecting surface, or any other suitable optical element that deflects, reflects, refracts, and/or in some way alters image light. Moreover, the optical assembly 630 may include combinations of different optical elements. In some embodiments, one or more of the optical elements in the optical assembly 630 may have one or more coatings, such as partially reflective or antireflective coatings.

In some embodiments, the optical assembly 630 may be designed to correct one or more types of optical errors. Examples of optical errors include barrel or pincushion distortions, longitudinal chromatic aberrations, or transverse chromatic aberrations. Other types of optical errors may further include spherical aberrations, chromatic aberrations or errors due to the lens field curvature, astigmatisms, in addition to other types of optical errors. In some embodiments, visual content transmitted to the display 625 is pre-distorted, and the optical assembly 630 corrects the distortion as image light from the display 625 passes through various optical elements of the optical assembly 630. In some embodiments, optical elements of the optical assembly 630 are integrated into the display 625 as a projection assembly that includes at least one waveguide coupled with one or more optical elements.

The IMU 640 is an electronic device that generates data indicating a position of the NED 605 based on measurement signals received from one or more of the position sensors 635 and from depth information received from the DCA 655. In some embodiments of the NED 605, the IMU 640 may be a dedicated hardware component. In other embodiments, the IMU 640 may be a software component implemented in one or more processors.

In operation, a position sensor 635 generates one or more measurement signals in response to a motion of the NED 605. Examples of position sensors 635 include: one or more accelerometers, one or more gyroscopes, one or more magnetometers, one or more altimeters, one or more inclinometers, and/or various types of sensors for motion detection, drift detection, and/or error detection. The position sensors 635 may be located external to the IMU 640, internal to the IMU 640, or some combination thereof.

Based on the one or more measurement signals from one or more position sensors 635, the IMU 640 generates data indicating an estimated current position of the NED 605 relative to an initial position of the NED 605. For example, the position sensors 635 include multiple accelerometers to measure translational motion (forward/back, up/down, left/right) and multiple gyroscopes to measure rotational motion (e.g., pitch, yaw, and roll). In some embodiments, the IMU 640 rapidly samples the measurement signals and calculates the estimated current position of the NED 605 from the sampled data. For example, the IMU 640 integrates the measurement signals received from the accelerometers over time to estimate a velocity vector and integrates the velocity vector over time to determine an estimated current position of a reference point on the NED 605. Alternatively, the IMU 640 provides the sampled measurement signals to the console 670, which analyzes the sample data to determine one or more measurement errors. The console 670 may further transmit one or more of control signals and/or measurement errors to the IMU 640 to configure the IMU 640 to correct and/or reduce one or more measurement errors (e.g., drift errors). The reference point is a point that may be used to describe the position of the NED 605. The reference point may generally be defined as a point in space or a position related to a position and/or orientation of the NED 605.

In various embodiments, the IMU 640 receives one or more parameters from the console 670. The one or more parameters are used to maintain tracking of the NED 605. Based on a received parameter, the IMU 640 may adjust one or more IMU parameters (e.g., a sample rate). In some embodiments, certain parameters cause the IMU 640 to update an initial position of the reference point so that it corresponds to a next position of the reference point. Updating the initial position of the reference point as the next calibrated position of the reference point helps reduce drift errors in detecting a current position estimate of the IMU 640.

In various embodiments, the eye tracking system 645 is integrated into the NED 605. The eye tracking system 645 may comprise one or more illumination sources (e.g., infrared illumination source, visible light illumination source) and one or more imaging devices (e.g., one or more cameras). In operation, the eye tracking system 645 generates and analyzes tracking data related to a user's eyes as the user wears the NED 605. In various embodiments, the eye tracking system 645 estimates the angular orientation of the user's eye. The orientation of the eye corresponds to the direction of the user's gaze within the NED 605. The orientation of the user's eye is defined herein as the direction of the foveal axis, which is the axis between the fovea (an area on the retina of the eye with the highest concentration of photoreceptors) and the center of the eye's pupil. In general, when a user's eyes are fixed on a point, the foveal axes of the user's eyes intersect that point. The pupillary axis is another axis of the eye that is defined as the axis passing through the center of the pupil and that is perpendicular to the corneal surface. The pupillary axis does not, in general, directly align with the foveal axis. Both axes intersect at the center of the pupil, but the orientation of the foveal axis is offset from the pupillary axis by approximately −1° to 6° laterally and ±4° vertically. Because the foveal axis is defined according to the fovea, which is located in the back of the eye, the foveal axis can be difficult or impossible to detect directly in some eye tracking embodiments. Accordingly, in some embodiments, the orientation of the pupillary axis is detected and the foveal axis is estimated based on the detected pupillary axis.

In general, movement of an eye corresponds not only to an angular rotation of the eye, but also to a translation of the eye, a change in the torsion of the eye, and/or a change in shape of the eye. The eye tracking system 645 may also detect translation of the eye, i.e., a change in the position of the eye relative to the eye socket. In some embodiments, the translation of the eye is not detected directly, but is approximated based on a mapping from a detected angular orientation. Translation of the eye corresponding to a change in the eye's position relative to the detection components of the eye tracking unit may also be detected. Translation of this type may occur, for example, due to a shift in the position of the NED 605 on a user's head. The eye tracking system 645 may also detect the torsion of the eye, i.e., rotation of the eye about the pupillary axis. The eye tracking system 645 may use the detected torsion of the eye to estimate the orientation of the foveal axis from the pupillary axis. The eye tracking system 645 may also track a change in the shape of the eye, which may be approximated as a skew or scaling linear transform or a twisting distortion (e.g., due to torsional deformation). The eye tracking system 645 may estimate the foveal axis based on some combination of the angular orientation of the pupillary axis, the translation of the eye, the torsion of the eye, and the current shape of the eye.

As the orientation may be determined for both eyes of the user, the eye tracking system 645 is able to determine where the user is looking. The NED 605 can use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other function that is based in part on the orientation of at least one of the user's eyes, or some combination thereof. Determining a direction of a user's gaze may include determining a point of convergence based on the determined orientations of the user's left and right eyes. A point of convergence may be the point that the two foveal axes of the user's eyes intersect (or the nearest point between the two axes). The direction of the user's gaze may be the direction of a line through the point of convergence and through the point halfway between the pupils of the user's eyes.

In some embodiments, the varifocal module 650 is integrated into the NED 605. The varifocal module 650 may be communicatively coupled to the eye tracking system 645 in order to enable the varifocal module 650 to receive eye tracking information from the eye tracking system 645. The varifocal module 650 may further modify the focus of image light emitted from the display 625 based on the eye tracking information received from the eye tracking system 645. Accordingly, the varifocal module 650 can reduce vergence-accommodation conflict that may be produced as the user's eyes resolve the image light. In various embodiments, the varifocal module 650 can be interfaced (e.g., either mechanically or electrically) with at least one optical element of the optical assembly 630.

In operation, the varifocal module 650 may adjust the position and/or orientation of one or more optical elements in the optical assembly 630 in order to adjust the focus of image light propagating through the optical assembly 630. In various embodiments, the varifocal module 650 may use eye tracking information obtained from the eye tracking system 645 to determine how to adjust one or more optical elements in the optical assembly 630. In some embodiments, the varifocal module 650 may perform foveated rendering of the image light based on the eye tracking information obtained from the eye tracking system 645 in order to adjust the resolution of the image light emitted by the display 625. In this case, the varifocal module 650 configures the display 625 to display a high pixel density in a foveal region of the user's eye-gaze and a low pixel density in other regions of the user's eye-gaze.

The I/O interface 675 facilitates the transfer of action requests from a user to the console 670. In addition, the I/O interface 675 facilitates the transfer of device feedback from the console 670 to the user. An action request is a request to perform a particular action. For example, an action request may be an instruction to start or end capture of image or video data or an instruction to perform a particular action within an application, such as pausing video playback, increasing or decreasing the volume of audio playback, and so forth. In various embodiments, the I/O interface 675 may include one or more input devices. Example input devices include: a keyboard, a mouse, a game controller, a joystick, and/or any other suitable device for receiving action requests and communicating the action requests to the console 670. In some embodiments, the I/O interface 675 includes an IMU 640 that captures calibration data indicating an estimated current position of the I/O interface 675 relative to an initial position of the I/O interface 675.

In operation, the I/O interface 675 receives action requests from the user and transmits those action requests to the console 670. Responsive to receiving the action request, the console 670 performs a corresponding action. For example, responsive to receiving an action request, console 670 may configure I/O interface 675 to emit haptic feedback onto an arm of the user. For example, console 670 may configure I/O interface 675 to deliver haptic feedback to a user when an action request is received. Additionally or alternatively, the console 670 may configure the I/O interface 675 to generate haptic feedback when the console 670 performs an action, responsive to receiving an action request.

The console 670 provides content to the NED 605 for processing in accordance with information received from one or more of: the DCA 655, the eye tracking system 645, one or more other components of the NED 605, and the I/O interface 675. In the embodiment shown in FIG. 6, the console 670 includes an application store 660 and an engine 665. In some embodiments, the console 670 may have additional, fewer, or different modules and/or components than those described in conjunction with FIG. 6. Similarly, the functions further described below may be distributed among components of the console 670 in a different manner than described in conjunction with FIG. 6.

The application store 660 stores one or more applications for execution by the console 670. An application is a group of instructions that, when executed by a processor, performs a particular set of functions, such as generating content for presentation to the user. For example, an application may generate content in response to receiving inputs from a user (e.g., via movement of the NED 605 as the user moves his/her head, via the I/O interface 675, etc.). Examples of applications include: gaming applications, conferencing applications, video playback applications, or other suitable applications.

In some embodiments, the engine 665 generates a three-dimensional mapping of the area surrounding the NED 605 (i.e., the “local area”) based on information received from the NED 605. In some embodiments, the engine 665 determines depth information for the three-dimensional mapping of the local area based on depth data received from the NED 605. In various embodiments, the engine 665 uses depth data received from the NED 605 to update a model of the local area and to generate and/or modify media content based in part on the updated model of the local area.

The engine 665 also executes applications within the NED system 600 and receives position information, acceleration information, velocity information, predicted future positions, or some combination thereof, of the NED 605. Based on the received information, the engine 665 determines various forms of media content to transmit to the NED 605 for presentation to the user. For example, if the received information indicates that the user has looked to the left, the engine 665 generates media content for the NED 605 that mirrors the user's movement in a virtual environment or in an environment augmenting the local area with additional media content. Accordingly, the engine 665 may generate and/or modify media content (e.g., visual and/or audio content) for presentation to the user. The engine 665 may further transmit the media content to the NED 605. Additionally, in response to receiving an action request from the I/O interface 675, the engine 665 may perform an action within an application executing on the console 670. The engine 665 may further provide feedback when the action is performed. For example, the engine 665 may configure the NED 605 to generate visual and/or audio feedback and/or the I/O interface 675 to generate haptic feedback to the user.

In some embodiments, based on the eye tracking information (e.g., orientation of the user's eye) received from the eye tracking system 645, the engine 665 determines a resolution of the media content provided to the NED 605 for presentation to the user on the display 625. The engine 665 may adjust a resolution of the visual content provided to the NED 605 by configuring the display 625 to perform foveated rendering of the visual content, based at least in part on a direction of the user's gaze received from the eye tracking system 645. The engine 665 provides the content to the NED 605 having a high resolution on the display 625 in a foveal region of the user's gaze and a low resolution in other regions, thereby reducing the power consumption of the NED 605. In addition, using foveated rendering reduces a number of computing cycles used in rendering visual content without compromising the quality of the user's visual experience. In some embodiments, the engine 665 can further use the eye tracking information to adjust a focus of the image light emitted from the display 625 in order to reduce vergence-accommodation conflicts.

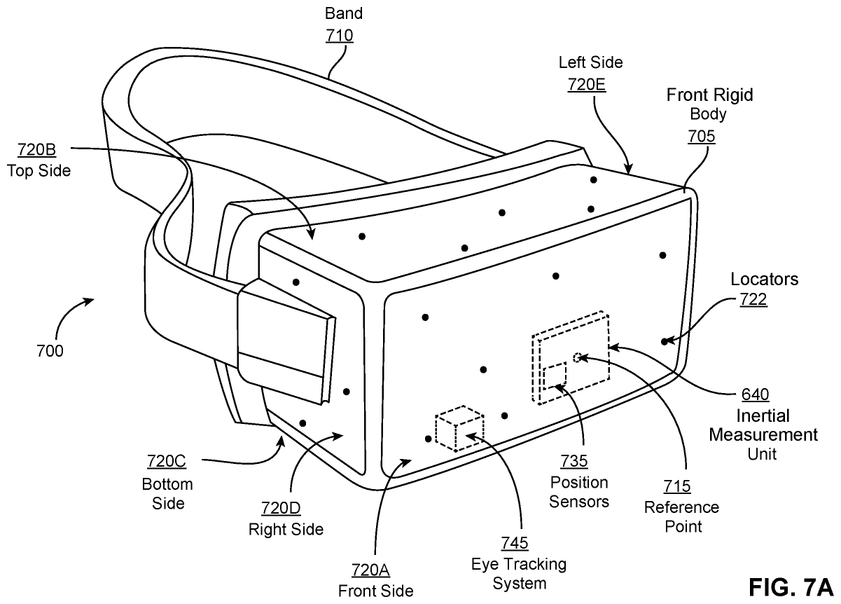

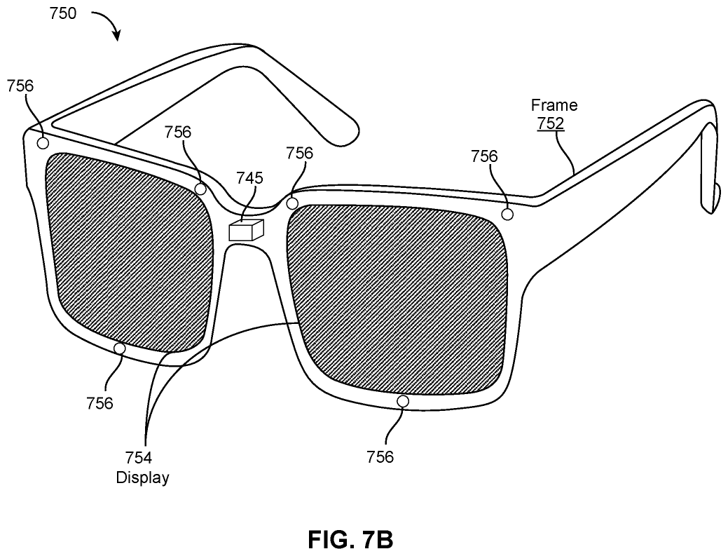

FIG. 7A is a diagram of an NED 700, according to various embodiments. In various embodiments, NED 700 presents media to a user. The media may include visual, auditory, and haptic content. In some embodiments, NED 700 provides artificial reality (e.g., virtual reality) content by providing a real-world environment and/or computer-generated content. In some embodiments, the computer-generated content may include visual, auditory, and haptic information. The NED 700 is an embodiment of the NED 605 and includes a front rigid body 705 and a band 710. The front rigid body 705 includes an electronic display element of the electronic display 625 (not shown in FIG. 7A), the optical assembly 630 (not shown in FIG. 7A), the IMU 640, the one or more position sensors 735, the eye tracking system 745, and the locators 722. In the embodiment shown by FIG. 7A, the position sensors 735 are located within the IMU 640, and neither the IMU 640 nor the position sensors 735 are visible to the user.

The locators 722 are located in fixed positions on the front rigid body 705 relative to one another and relative to a reference point 715. In the example of FIG. 7A, the reference point 715 is located at the center of the IMU 640. Each of the locators 722 emits light that is detectable by the imaging device in the DCA 655. The locators 722, or portions of the locators 722, are located on a front side 720A, a top side 720B, a bottom side 720C, a right side 720D, and a left side 720E of the front rigid body 705 in the example of FIG. 7A.

The NED 700 includes the eye tracking system 745. As discussed above, the eye tracking system 745 may include a structured light generator that projects an interferometric structured light pattern onto the user's eye and a camera to detect the illuminated portion of the eye. The structured light generator and the camera may be located off the axis of the user's gaze. In various embodiments, the eye tracking system 745 may include, additionally or alternatively, one or more time-of-flight sensors and/or one or more stereo depth sensors. In FIG. 7A, the eye tracking system 745 is located below the axis of the user's gaze, although the eye tracking system 745 can alternately be placed elsewhere. Also, in some embodiments, there is at least one eye tracking unit for the left eye of the user and at least one tracking unit for the right eye of the user.

In various embodiments, the eye tracking system 745 includes one or more cameras on the inside of the NED 700. The camera(s) of the eye tracking system 745 may be directed inwards, toward one or both eyes of the user while the user is wearing the NED 700, so that the camera(s) may image the eye(s) and eye region(s) of the user wearing the NED 700. The camera(s) may be located off the axis of the user's gaze. In some embodiments, the eye tracking system 745 includes separate cameras for the left eye and the right eye (e.g., one or more cameras directed toward the left eye of the user and, separately, one or more cameras directed toward the right eye of the user).

FIG. 7B is a diagram of an NED 750, according to various embodiments. In various embodiments, NED 750 presents media to a user. The media may include visual, auditory, and haptic content. In some embodiments, NED 750 provides artificial reality (e.g., augmented reality) content by providing a real-world environment and/or computer-generated content. In some embodiments, the computer-generated content may include visual, auditory, and haptic information. The NED 750 is an embodiment of the NED 605.

NED 750 includes frame 752 and display 754. In various embodiments, the NED 750 may include one or more additional elements. Display 754 may be positioned at different locations on the NED 750 than the locations illustrated in FIG. 7B. Display 754 is configured to provide content to the user, including audiovisual content. In some embodiments, one or more displays 754 may be located within frame 752.

NED 750 further includes eye tracking system 745 and one or more corresponding modules 756. The modules 756 may include emitters (e.g., light emitters) and/or sensors (e.g., image sensors, cameras). In various embodiments, the modules 756 are arranged at various positions along the inner surface of the frame 752, so that the modules 756 are facing the eyes of a user wearing the NED 750. For example, the modules 756 could include emitters that emit structured light patterns onto the eyes and image sensors to capture images of the structured light pattern on the eyes. As another example, the modules 756 could include multiple time-of-flight sensors for directing light at the eyes and measuring the time of travel of the light at each pixel of the sensors. As a further example, the modules 756 could include multiple stereo depth sensors for capturing images of the eyes from different vantage points. In various embodiments, the modules 756 also include image sensors for capturing 2D images of the eyes.

In sum, the disclosed techniques train and execute a series of machine learning models to perform a virtual try-on task, in which an image of a person is combined with an image of a garment into an output image that depicts the person wearing the garment. The machine learning models include a flow estimation model that extracts a global context that encodes the structure and visual attributes of the image of the garment and the image of the person onto which the garment is to be fitted. The flow estimation model iteratively uses the global context to predict a coarse appearance flow between the images and uses local correspondence between feature maps mapped to one another via the coarse appearance flow to generate a refinement flow. The flow estimation model also combines the coarse appearance flow and refinement flow into an appearance flow that is used to warp the garment. The machine learning models additionally include a rendering model with a residual U-net architecture. Input into the rendering model includes the warped garment, a dense pose for the image of the person, and a masked version of the image of the person that excludes regions into which the garment is to be inserted. In response to the input, the rendering network outputs a corresponding image of the person wearing the garment.

One technical advantage of the disclosed techniques relative to the prior art is the ability to generate appearance flows that account for significant spatial misalignment between a garment depicted in one image and a person depicted in another image. Accordingly, the disclosed techniques can be used to generate more accurate or realistic virtual try-on results than conventional approaches that use only local feature correspondences between features representing an image of the garment and features representing an image of the person to perform appearance flow estimation. Another technical advantage of the disclosed techniques is the use of detailed semantic segmentation information to mask a region within the image of the person into which a specific type of garment is to be placed. Accordingly, the disclosed techniques allow a variety of garments (tops, bottoms, accessories, shoes, hats, etc.) to be combined with people or body parts depicted in images in a seamless manner. These technical advantages provide one or more technological improvements over prior art approaches.
1. In some embodiments, a computer-implemented method for performing a virtual try-on task comprises determining a dense pose associated with a first figure depicted in a first image; converting, based on the dense pose, a second image of a first garment into a third image of a first warped garment; inputting the dense pose, one or more regions of the first image, and the third image of the first warped garment into a first neural network; and generating, via execution of the first neural network, an output image that depicts the first figure wearing the first garment.
2. The computer-implemented method of clause 1, wherein converting the second image of the first garment into the third image of the first warped garment comprises inputting the dense pose and the second image into a second neural network; and executing the second neural network to generate the third image of the first warped garment.
3. The computer-implemented method of any of clauses 1-2, wherein executing the second neural network comprises executing a first encoder included in the second neural network to convert the dense pose into a first set of feature maps; executing a second encoder included in the second neural network to convert the second image into a second set of feature maps; and generating an appearance flow between the second image and the third image based on the first set of feature maps and the second set of feature maps.
4. The computer-implemented method of any of clauses 1-3, wherein executing the second neural network comprises generating a coarse appearance flow based on a first set of feature maps associated with the dense pose and a second set of feature maps associated with the second image; generating a refinement flow based on the coarse appearance flow and a receptive field associated with the first set of feature maps and the second set of feature maps; aggregating the coarse appearance flow and the refinement flow into an appearance flow between the second image and the third image; and applying the appearance flow to the second image to generate the third image.
5. The computer-implemented method of any of clauses 1-4, further comprising training the first neural network based on a first training image that depicts a second figure wearing a second garment and a second training image that depicts the second garment.
6. The computer-implemented method of any of clauses 1-5, wherein training the first neural network comprises updating parameters of the first neural network based on an adversarial loss associated with a reconstruction of the first training image generated by the first neural network.
7. The computer-implemented method of any of clauses 1-6, wherein training the first neural network comprises updating parameters of the first neural network based on a perceptual loss associated with a skin region in the first training image by the first neural network.
8. The computer-implemented method of any of clauses 1-7, further comprising determining the one or more regions of the first image based on a semantic segmentation of the first image.
9. The computer-implemented method of any of clauses 1-8, wherein the first neural network comprises a residual U-net.
10. The computer-implemented method of any of clauses 1-9, wherein the first figure depicted in the first image comprises a person wearing a second garment.
11. In some embodiments, one or more non-transitory computer-readable media store instructions that, when executed by one or more processors, cause the one or more processors to perform the steps of determining a dense pose associated with a first figure depicted in a first image; converting, based on the dense pose, a second image of a first garment into a third image of a first warped garment; inputting the dense pose, one or more regions of the first image, and the third image of the first warped garment into a first neural network; and generating, via execution of the first neural network, an output image that depicts the first figure wearing the first garment.
12. The one or more non-transitory computer-readable media of clause 11, wherein converting the second image into the third image comprises inputting the dense pose and the second image into a second neural network; and executing the second neural network to generate the third image of the first warped garment.
13. The one or more non-transitory computer-readable media of any of clauses 11-12, wherein converting the second image into the third image comprises executing a first encoder neural network to convert the dense pose into a first set of feature maps; executing a second encoder neural network to convert the second image into a second set of feature maps; and executing a warping neural network to generate an appearance flow between the second image and the third image based on the first set of feature maps and the second set of feature maps.
14. The one or more non-transitory computer-readable media of any of clauses 11-13, wherein converting the second image into the third image comprises generating a coarse appearance flow based on a first set of feature maps associated with the dense pose and a second set of feature maps associated with the second image; generating a refinement flow based on the coarse appearance flow and a receptive field associated with the first set of feature maps and the second set of feature maps; aggregating the coarse appearance flow and the refinement flow into an appearance flow between the second image and the third image; and applying the appearance flow to the second image to generate the third image.
15. The one or more non-transitory computer-readable media of any of clauses 11-14, wherein the instructions further cause the one or more processors to perform the step of training the first neural network based on a first training image that depicts a second figure wearing a second garment, a second training image that depicts the second garment, and one or more losses.
16. The one or more non-transitory computer-readable media of any of clauses 11-15, wherein the one or more losses comprise at least one of an adversarial loss associated with a reconstruction of the first training image generated by the first neural network or a perceptual loss associated with a skin region in the first training image by the first neural network.
17. The one or more non-transitory computer-readable media of any of clauses 11-16, wherein the first neural network comprises an encoder, a decoder, and one or more skip connections.
18. The one or more non-transitory computer-readable media of any of clauses 11-17, wherein the instructions further cause the one or more processors to perform the steps of computing an aggregation of a semantic segmentation of the first image and the dense pose; and determining, based on the aggregation, the one or more regions of the first image that lie outside a region to be occupied by the first garment.
19. The one or more non-transitory computer-readable media of any of clauses 11-18, wherein the one or more regions of the first image depict at least one of a head, an upper body, or a lower body.
20. In some embodiments, a system comprises one or more memories that store instructions, and one or more processors that are coupled to the one or more memories and, when executing the instructions, are configured to perform the steps of determining a dense pose associated with a first figure depicted in a first image; converting, based on the dense pose, a second image of a first garment into a third image of a first warped garment; inputting the dense pose, one or more regions of the first image, and the third image of the first warped garment into a first neural network; and generating, via execution of the first neural network, an output image that depicts the first figure wearing the first garment.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing a virtual try-on task, the method comprising:
determining a dense pose associated with a first figure depicted in a first image;
converting, based on the dense pose, a second image of a first garment into a third image of a first warped garment;
inputting the dense pose, one or more regions of the first image, and the third image of the first warped garment into a first neural network; and
generating, via execution of the first neural network, an output image that depicts the first figure wearing the first garment.

2. The computer-implemented method of claim 1, wherein converting the second image of the first garment into the third image of the first warped garment comprises:
inputting the dense pose and the second image into a second neural network; and
executing the second neural network to generate the third image of the first warped garment.

3. The computer-implemented method of claim 2, wherein executing the second neural network comprises:
executing a first encoder included in the second neural network to convert the dense pose into a first set of feature maps;
executing a second encoder included in the second neural network to convert the second image into a second set of feature maps; and
generating an appearance flow between the second image and the third image based on the first set of feature maps and the second set of feature maps.

4. The computer-implemented method of claim 2, wherein executing the second neural network comprises:
generating a coarse appearance flow based on a first set of feature maps associated with the dense pose and a second set of feature maps associated with the second image;
generating a refinement flow based on the coarse appearance flow and a receptive field associated with the first set of feature maps and the second set of feature maps;
aggregating the coarse appearance flow and the refinement flow into an appearance flow between the second image and the third image; and
applying the appearance flow to the second image to generate the third image.

5. The computer-implemented method of claim 1, further comprising training the first neural network based on a first training image that depicts a second figure wearing a second garment and a second training image that depicts the second garment.

6. The computer-implemented method of claim 5, wherein training the first neural network comprises updating parameters of the first neural network based on an adversarial loss associated with a reconstruction of the first training image generated by the first neural network.

7. The computer-implemented method of claim 5, wherein training the first neural network comprises updating parameters of the first neural network based on a perceptual loss associated with a skin region in the first training image by the first neural network.

8. The computer-implemented method of claim 1, further comprising determining the one or more regions of the first image based on a semantic segmentation of the first image.

9. The computer-implemented method of claim 1, wherein the first neural network comprises a residual U-net.

10. The computer-implemented method of claim 1, wherein the first figure depicted in the first image comprises a person wearing a second garment.

11. One or more non-transitory computer-readable media storing instructions that, when executed by one or more processors, cause the one or more processors to perform the steps of:
determining a dense pose associated with a first figure depicted in a first image;
converting, based on the dense pose, a second image of a first garment into a third image of a first warped garment;
inputting the dense pose, one or more regions of the first image, and the third image of the first warped garment into a first neural network; and
generating, via execution of the first neural network, an output image that depicts the first figure wearing the first garment.

12. The one or more non-transitory computer-readable media of claim 11, wherein converting the second image into the third image comprises:
inputting the dense pose and the second image into a second neural network; and
executing the second neural network to generate the third image of the first warped garment.

13. The one or more non-transitory computer-readable media of claim 11, wherein converting the second image into the third image comprises:
executing a first encoder neural network to convert the dense pose into a first set of feature maps;
executing a second encoder neural network to convert the second image into a second set of feature maps; and
executing a warping neural network to generate an appearance flow between the second image and the third image based on the first set of feature maps and the second set of feature maps.

14. The one or more non-transitory computer-readable media of claim 11, wherein converting the second image into the third image comprises:
generating a coarse appearance flow based on a first set of feature maps associated with the dense pose and a second set of feature maps associated with the second image;
generating a refinement flow based on the coarse appearance flow and a receptive field associated with the first set of feature maps and the second set of feature maps;
aggregating the coarse appearance flow and the refinement flow into an appearance flow between the second image and the third image; and
applying the appearance flow to the second image to generate the third image.

15. The one or more non-transitory computer-readable media of claim 11, wherein the instructions further cause the one or more processors to perform the step of training the first neural network based on a first training image that depicts a second figure wearing a second garment, a second training image that depicts the second garment, and one or more losses.

16. The one or more non-transitory computer-readable media of claim 15, wherein the one or more losses comprise at least one of an adversarial loss associated with a reconstruction of the first training image generated by the first neural network or a perceptual loss associated with a skin region in the first training image by the first neural network.

17. The one or more non-transitory computer-readable media of claim 11, wherein the first neural network comprises an encoder, a decoder, and one or more skip connections.

18. The one or more non-transitory computer-readable media of claim 11, wherein the instructions further cause the one or more processors to perform the steps of:
computing an aggregation of a semantic segmentation of the first image and the dense pose; and
determining, based on the aggregation, the one or more regions of the first image that lie outside a region to be occupied by the first garment.

19. The one or more non-transitory computer-readable media of claim 11, wherein the one or more regions of the first image depict at least one of a head, an upper body, or a lower body.

20. A system, comprising:
one or more memories that store instructions, and
one or more processors that are coupled to the one or more memories and, when executing the instructions, are configured to perform the steps of:
determining a dense pose associated with a first figure depicted in a first image;
converting, based on the dense pose, a second image of a first garment into a third image of a first warped garment;
inputting the dense pose, one or more regions of the first image, and the third image of the first warped garment into a first neural network; and
generating, via execution of the first neural network, an output image that depicts the first figure wearing the first garment.
